(19) United States
(12) Patent Application Publication
(10) Pub. No.: US 2004/0170439 A1
(43) Pub. Date: Sep. 2, 2004

(54) Method and apparatus for an optical cdma system

(76) Inventor: Olli-Pekka Hiironen, Espoo (FI)

Correspondence Address: HARRINGTON & SMITH, LLP, 4 RESEARCH DRIVE, SHELTON, CT, 06484-6212, US

(21) Appl. No.: 10/482,523

(22) PCT Filed: Jul. 1, 2002
(86) PCT No.: PCT/FI02/00584

(30) Foreign Application Priority Data
Jun. 29, 2001 (FI) 20011420

(51) Int. Cl. H04B 10/04

(52) U.S. Cl. 398/190

(57) ABSTRACT

A method and an apparatus for transmitting an optical signal in an optical CDMA system. The system comprises transceivers (101 to 104) capable of sending and receiving optical signal sent and received through an optical fibre network. The optical signal is generated in a transmitter (100) where a digital data signal is at first pulse position modulated as a data symbol. Frequency hopping coding is conducted for the data symbol, and thereafter the data symbol is sent to a receiver (106) where the frequency hopping decoding and PPM demodulation are conducted.

### BACKGROUND OF THE INVENTION

The OCDMA system is a new way to flexibly divide an optical fibre network without requiring complex signal processing. Various methods can be employed to implement the OCDMA system; the most commonly used being the coherent, incoherent, synchronous or asynchronous methods. The methods can additionally be based on the signal's time or spectrum coding or on a combination of both the aforementioned.

Most transmission systems employ binary transmission of data symbols, such as on-off Keying, OOK, in which the data-source, for example a led (light emitting diode), is switched on for 1-bit and off for 0-bit. Another alternative is to use for instance pulse position modulation, PPM, which has been proven to improve the susceptibility of the system and to offer a chance to serve several users simultaneously in comparison to what the on-off keying provides in the time coding or spectrum coding OCDMA system.

Prior art FH-OCDMA systems use binary transmission of data, typically on-off keying, OOK. Pulse position modulation has previously been used in the time and spectrum coding OCDMA systems.

In the OOK-CDMA systems, the bit error rate BER has involved such a restriction that it has been impossible to increase the total number of simultaneous users without increasing the average power. Even though the average power is increased, all users cannot profit there from simultaneously. In the OOK-CDMA systems, the throughput capacity and user capacity limitations depend on the number of users and on the code lengths used in the coding.

To detect a pulse signal has typically been difficult in the OCDMA system. In OOK keying, the pulse signal is indicated by comparing the power level to the threshold value at a particular instant of time. If the power of the pulse exceeds said threshold value, 1-bit is indicated, and correspondingly 0-bit is indicated if the power level of the pulse is smaller than said threshold value. In the PPM signalling mode, each M-ary data symbol is shown as an individual light pulse, which is addressed to one of the possible M pulse positions. At the reception end the pulse power level of each pulse position is indicated and the pulse position, whose pulse includes the highest power level, is indicated as a sent symbol.

What causes changes to the power level of the pulse signal in incoherent OCDMA systems are the pulses of other users (multiple-access interference, MAI) and noise, such as the noise occurring between pulses (beat noise), the receiver's noise and the transmitter's thermal noise (if LED is used to form the pulse). In order to achieve an adequate bit error rate, the power level (OOK system) between 1- and 0-bits or the power level (PPM system) between the pulse positions should be adequate enough. Several ways including specific drawbacks exist to increase the difference between 1- and 0-bits. A drawback, when increasing the length of the code to be used in coding, is the more complex and expensive coding means or a lower bit rate in data transmission. When employing transmission means provided with less noise, the price becomes a restricting factor. If higher signal power is desired, optical amplifiers are required on the route, or the distance between the transmitter and receiver means should be reduced.

In accordance with the prior art, FH OCDMA systems using frequency hopping employ only one photodiode for detecting pulse signals (typically on-off keying). The use of a single photodiode for indicating all frequency pulses received at the same instant of time causes loss of information when converting the optical pulse into electric mode, since the number of indicated frequency pulses might be incorrect owing to eventual interference.

In on-off keying, the worst possible situation when other users cause interference may last for such a long uninterrupted time that the advantage over the statistical multiplexing is lost. The bit error rate also changes slowly in relation to time owing to the stability of the synchronization means of the signal source.

### SUMMARY OF THE INVENTION

A method and a system have been invented for using pulse position modulation in FH OCDMA systems. The method and system of the invention can be used to increase the number of simultaneous users in the system by increasing the length of the sequence to be coded and by simultaneously maintaining the power to be used in the transmission unchanged.

The PPM-FH-OCDMA system has a better and more stable bit error rate, which is also more efficient than the OOK-CDMA system. On account of the pulse position modulation, the interferences caused by several users change so rapidly that the system benefits from the statistical multiplexing. To detect the frequency pulse components in separate detectors allows a better bit error rate, when operating in an environment described in the prior art (same bit level, an equal number of users, identical coding), since the setting of threshold values is easier, and the information included in the frequency pulses is utilized. Then again, if the bit error rate is maintained at a conventional level, then several simultaneous users can be provided to the system, or correspondingly shorter and simpler codes are provided, in which case data transmission can be accelerated.

According to a first aspect of the invention, a method is provided for generating an optical data signal of a digital data signal comprising at least two data bits, where said data signal is converted into a data symbol of the M-ary number system, characterized by comprising the steps of pulse position modulating said data symbol to an optical pulse sequence, frequency hopping coding said optical pulse sequence to an optical data signal.

According to a second aspect of the invention, a method is provided for generating a digital data signal of a received optical data signal, characterized in that said optical data signal is pulse position modulated and coded using frequency hopping and comprises at least two frequency pulse components, and the method comprises the steps of: receiving frequency pulse components, converting said frequency pulse components into electrical pulses, conducting frequency hopping coding for said received frequency pulse components, or for said electrical pulses, by delaying said frequency pulse components or said electrical pulses in relation to one another to the same instant of time, calculating the number of said electrical pulses in the different pulse positions of the PPM sequence, selecting the pulse position in the PPM sequence with most pulses as the data symbol, and pulse position demodulating said data symbol to a data bit string.

According to a third aspect of the invention, a transmitter apparatus is provided for sending an optical data signal in an optical CDMA system, the apparatus comprising a data source for generating a data signal comprising at least two data bits, a light pulse source for presenting said data signal as an optical signal, transmission means for sending said optical signal from the transmitter apparatus, and conversion means for converting said data signal into a data symbol of the M-ary number system, characterized in that said transmitter apparatus further comprises; modulation means for pulse position modulating said data symbol to an optical pulse sequence, and a frequency hopping encoder for coding said optical pulse sequence to an optical data signal in time and frequency domain.

According to a fourth aspect of the invention, a receiver apparatus is provided for receiving an optical data signal in an optical CDMA system, the receiver apparatus comprising means for receiving the optical data signal at the receiver apparatus, characterized in that said optical data signal is pulse position modulated and coded using frequency hopping and comprises at least two frequency pulse components, and the receiver apparatus further comprises reception means for receiving at least two optical frequency pulse components, conversion means for converting the frequency pulse components into corresponding electrical pulses, decoding means for conducting frequency hopping decoding for said received frequency pulse components, for said divided frequency pulse components or for said electrical pulses, by delaying said pulses in relation to one another to the same instant of time, calculation means for calculating the number of said electrical pulses in the different pulse positions of the PPM sequence.

According to a fifth aspect of the invention, a system is provided comprising an optical fibre network, at least two transceiver apparatuses, which are able to send and receive optical data signals through said fibre network, a data source for generating a data signal comprising at least two data bits, a light pulse source for presenting said data signal as an optical signal, transmission means for sending said optical signal, and means for receiving the optical data signal, and conversion means for converting said data signal into a data symbol of the M-ary number system, characterized in that said optical data signal is pulse position modulated and coded using frequency hopping and comprises at least two frequency hopping components and that the system also comprises: modulation means for pulse position modulating said data symbol to an optical pulse sequence, a frequency hopping encoder for coding said optical pulse sequence in time and frequency domain to an optical pulse signal, reception means for receiving at least the optical pulse signal comprising at least two optical frequency components, conversion means for converting said frequency pulse components using said frequency pulse detectors into corresponding electrical pulses, coding means for conducting frequency how ping decoding for said received frequency pulse components, or for said electrical pulses by delaying said pulses in relation to one another to the same instants of time; calculation means for calculating the number of said electrical pulses in the different pulse positions of the PPM sequence, selection means for selecting a data symbol by selecting the pulse position with most pulses as the data symbol, and demodulation means for demodulating said data symbol to a data bit string.

In the following the invention will be described in greater detail with reference to the accompanying drawings, in which

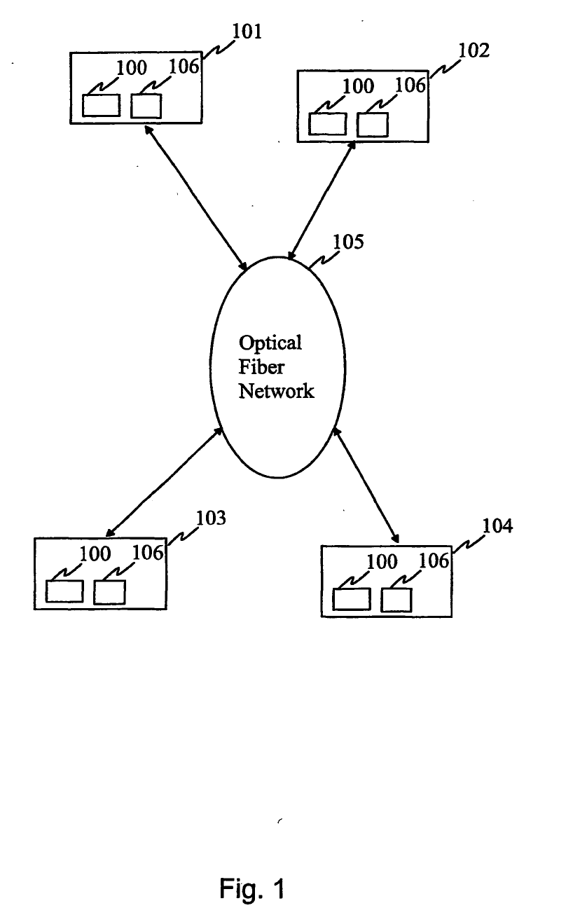

FIG. 1 shows a system of the invention,

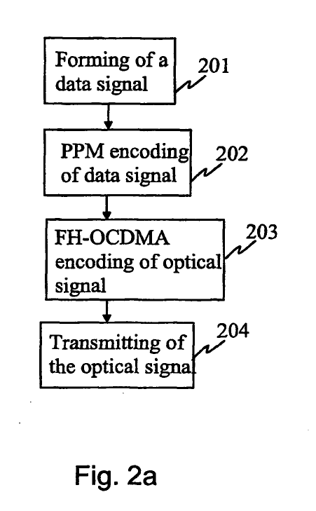

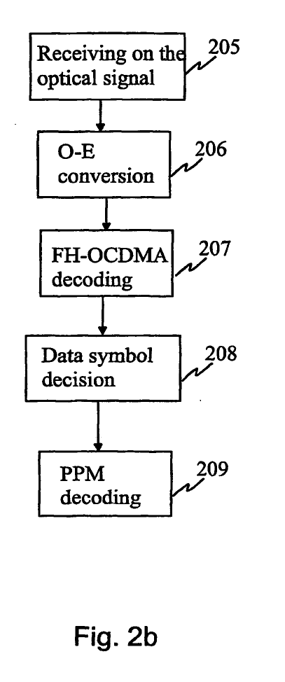

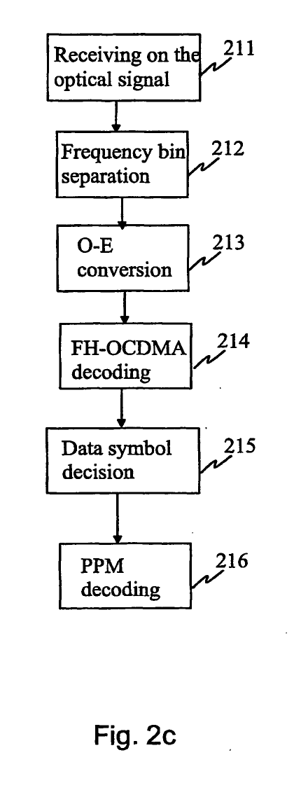

FIG. 2a is a flow chart showing the method of the invention for sending an optical signal,

FIG. 2b is a flow chart showing the method of the invention for receiving an optical signal,

FIG. 2c is a flow chart showing an alternative method of the invention for receiving an optical signal,

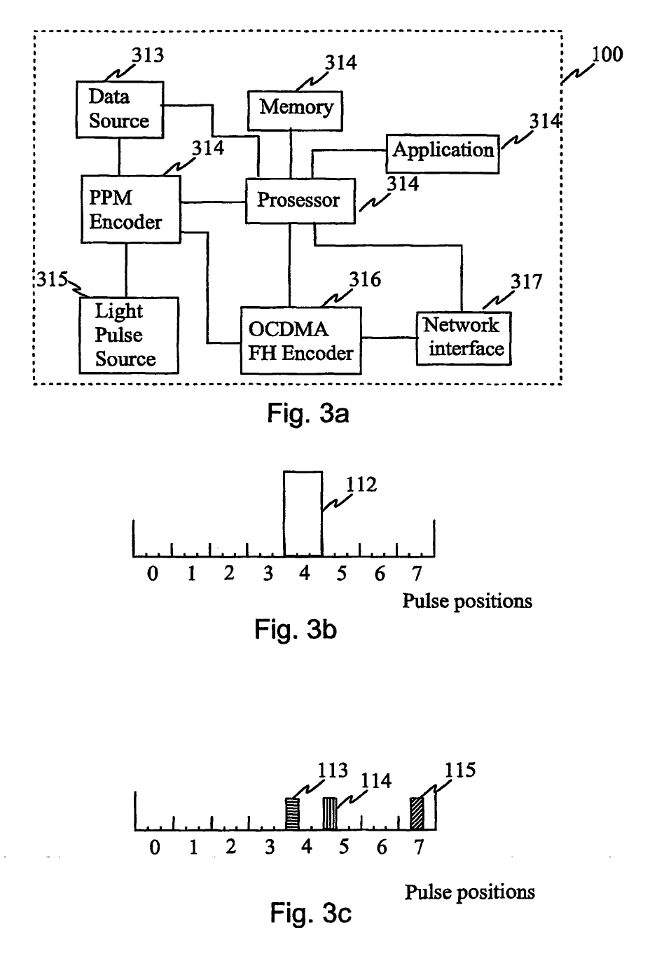

FIG. 3a is a block diagram showing a transmitter according to an embodiment of the invention,

FIGS. 3b and 3c show how the transmitter of the invention is used to generate an optical signal,

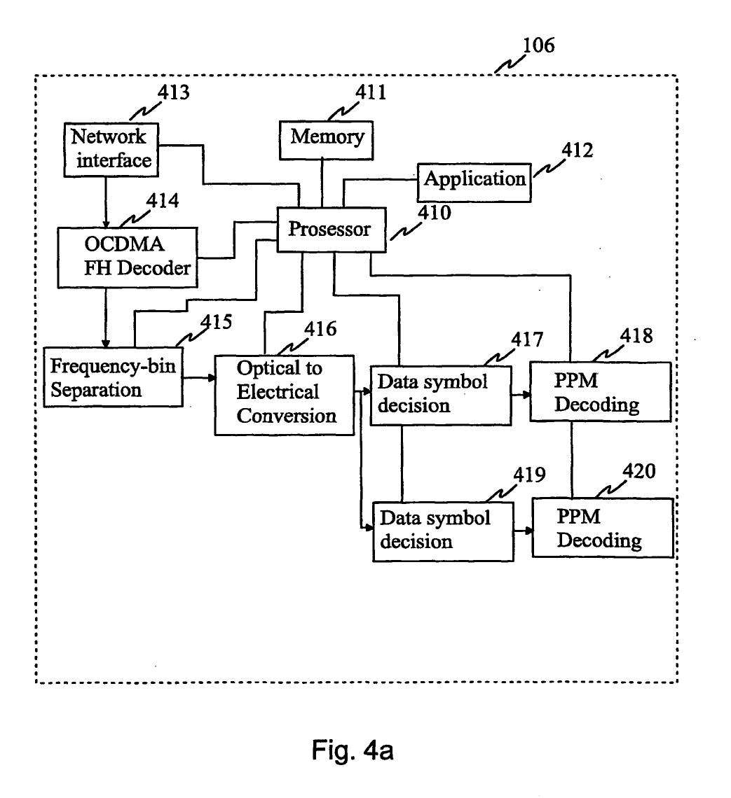

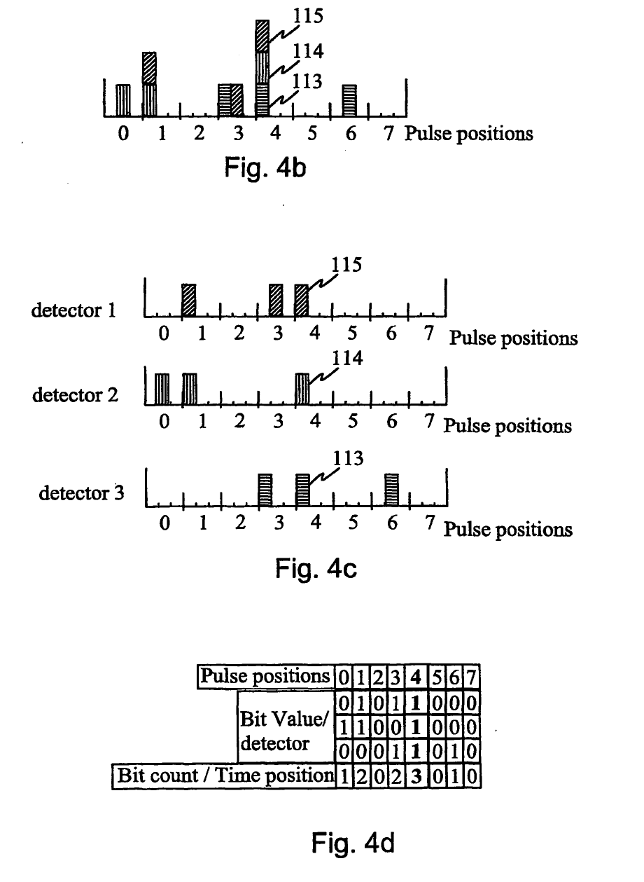

FIG. 4a is a block diagram showing a receiver according to an embodiment of the invention,

FIGS. 4b, 4c and 4d show how the receiver of the invention is used to change the optical signal to a data signal,

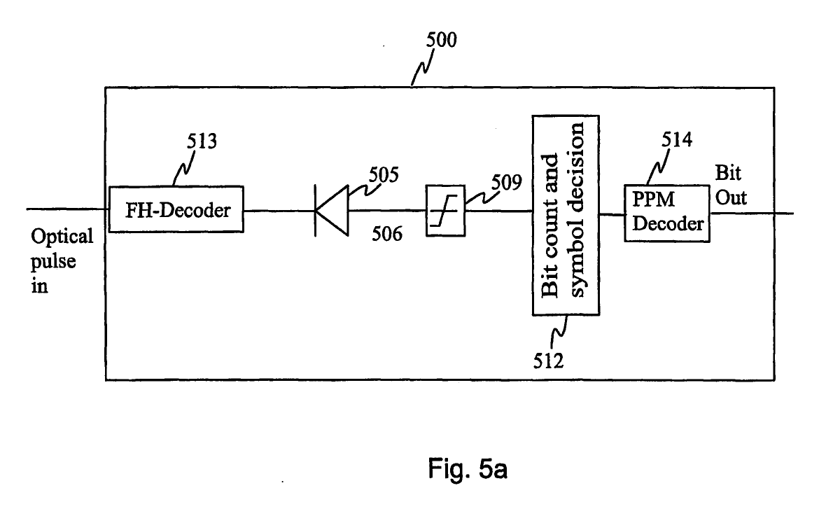

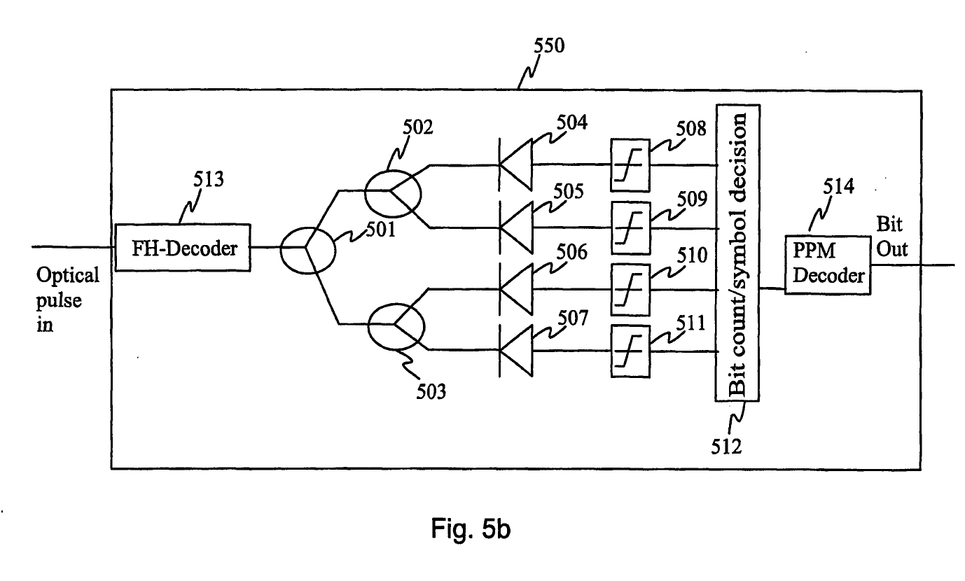

FIG. 5a shows a receiver according to an embodiment of the invention,

FIG. 5b shows a receiver according to an alternative embodiment of the invention,

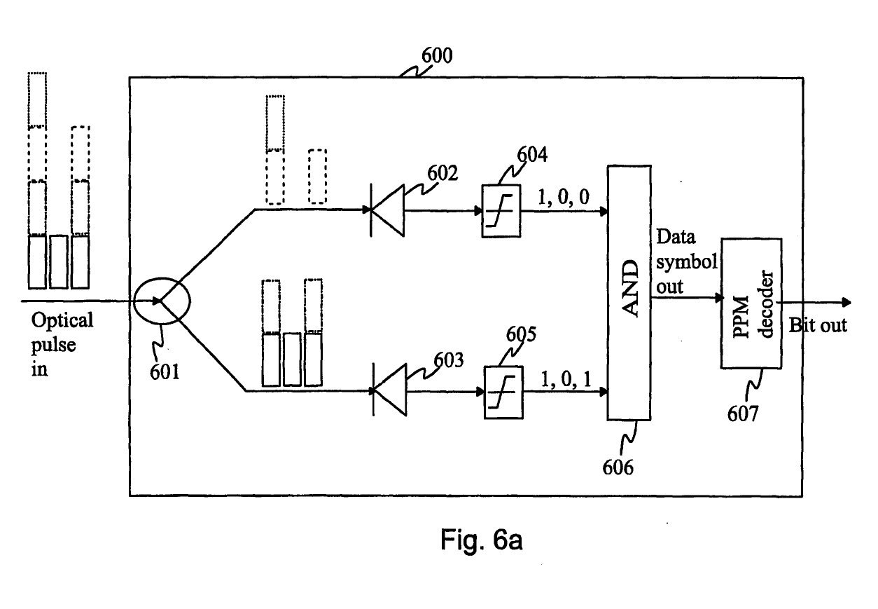

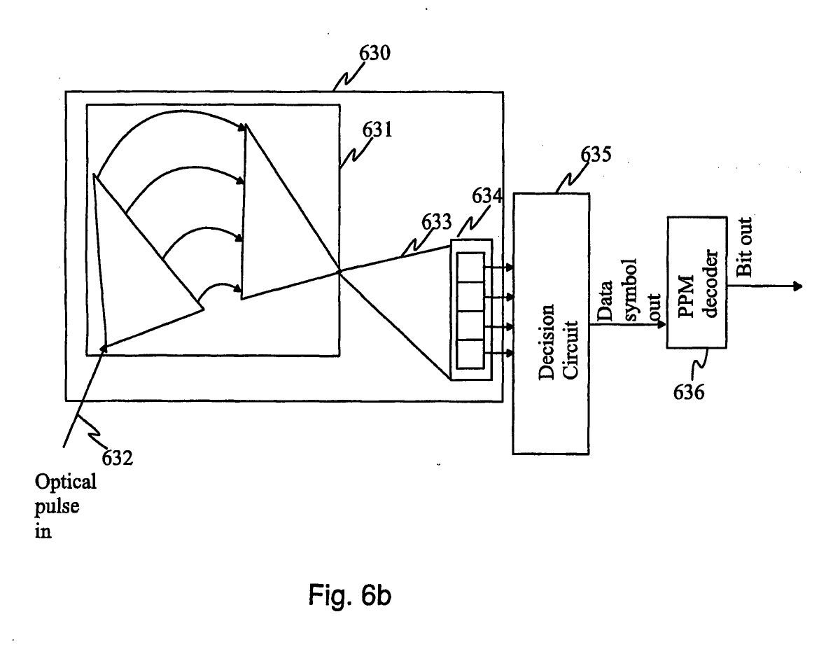

FIG. 6a shows an alternative embodiment for receiving frequency pulse components,

FIG. 6b shows a receiver according to an alternative embodiment of the invention comprising an integrated combination of a wavelength separator and a photo detector,

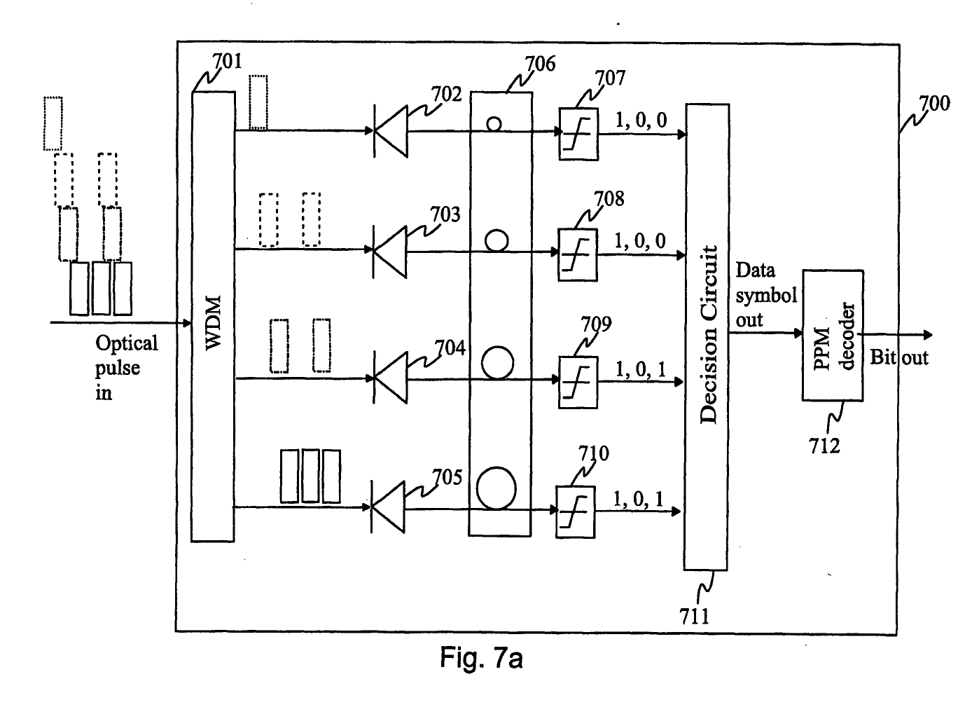

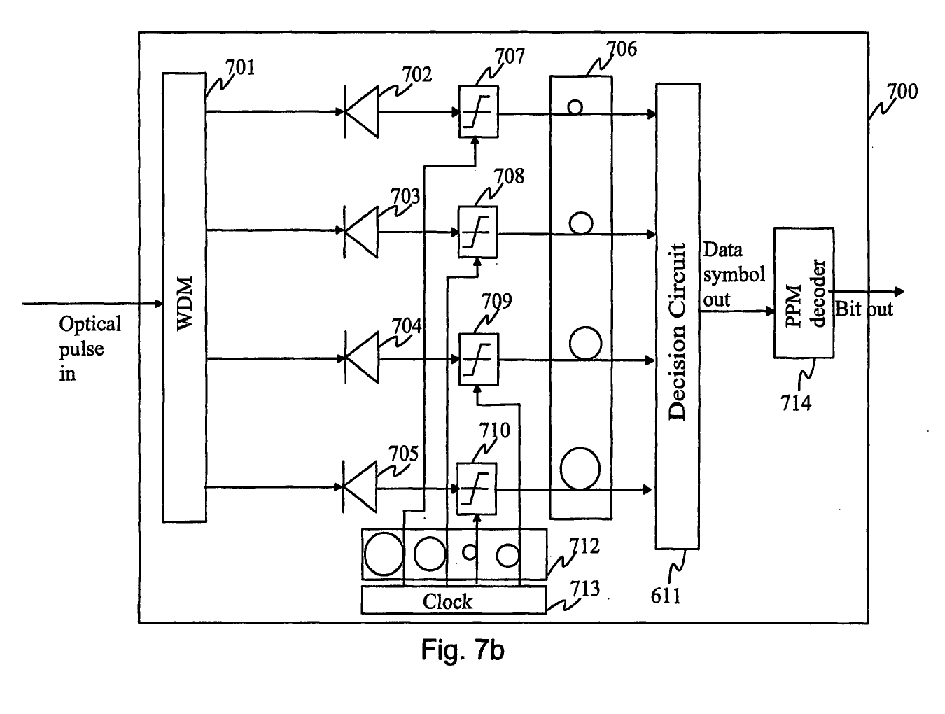

FIG. 7a shows an apparatus according to an alternative embodiment of the invention using dispersion compensation,

FIG. 7b shows an alternative embodiment for the apparatus shown in FIG. 7a,

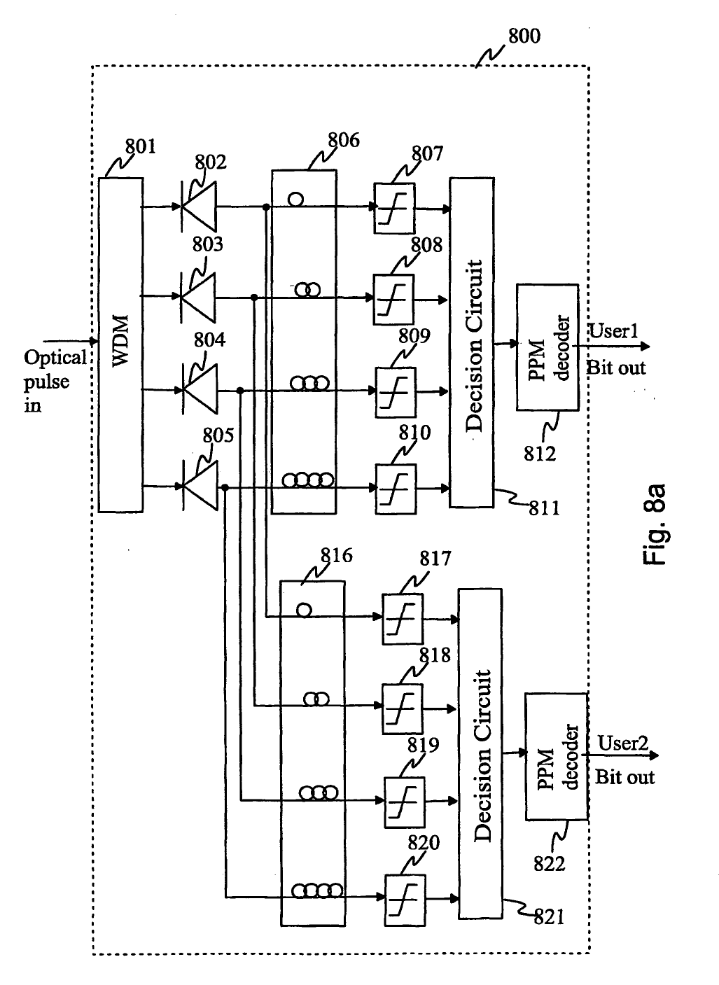

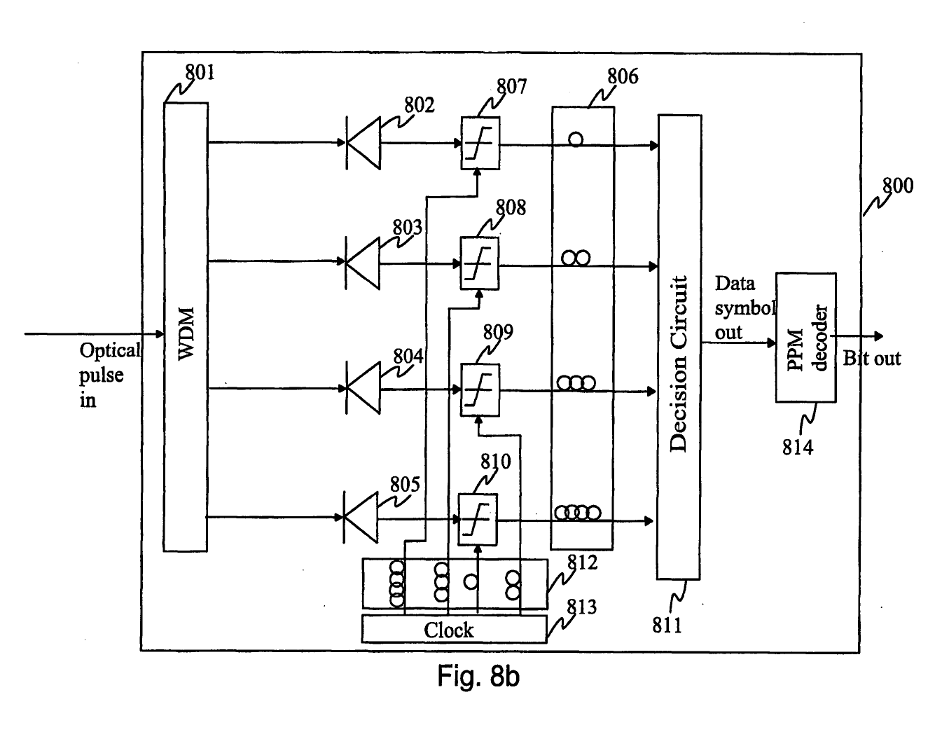

FIG. 8a shows an apparatus according to an embodiment of the invention using frequency hopping decoding,

FIG. 8b shows an alternative embodiment for the apparatus shown in FIG. 8a.

FIG. 1 shows a system of the invention comprising apparatuses 101 to 104 that further comprise an OCDMA transmitter 100 and an OCDMA receiver 106. The transmitter 100 is shown in greater detail in FIG. 3a and the receiver 106 is shown in more detail in FIG. 4a. The apparatuses 101 to 104 are connected to an optical fibre network 105 through which network the apparatuses are able to send and receive optical pulse position modulated data signal that is decoded using frequency hopping. The apparatus 101 to 104 may for instance be a server, like a network server or a computer connected to an optical fibre network.

The following example illustrates how the system operates. The apparatus 101 generates a data signal in digital mode and converts the data signal in the transmitter 100 thereof into a pulse position modulated data symbol and said data symbol further into an optical data signal coded using frequency hopping, the data signal comprising at least two optical frequency pulse components of different frequencies and of different instants of time. Said frequency pulse components are sent through the optical network 105 to the receiver 104. Correspondingly the apparatus 102 sends the coded optical data signal generated in the transmitter 100 thereof to a receiving apparatus 103. The sent coded optical data signal is received in all other apparatuses except for the apparatus that sent said data signal. In the case shown in the example, the apparatuses 102 to 104 receive the data signal coded and sent by the apparatus 101, and correspondingly the apparatuses 101, 103 and 104 receive the data signal coded and sent by the apparatus 102.

The apparatus 104 receives in the receiver 106 thereof the optical data signal sent from both the apparatus 101 and the apparatus 102. Said receiver 106 conducts frequency hopping coding corresponding to the frequency hopping coding of the apparatus 101, where after the frequency pulse components sent from the apparatus 101 are delayed in relation to one another back to the same instant of time that prevailed before the transmission and correspondingly the frequency pulse components of the apparatus 102 are delayed in the apparatus 104 in accordance with the code employed. However, since the coding used in the apparatuses 102 and 104 is different, the frequency pulse components sent by the apparatus 102 are spread to different instants of time.

The frequency pulse components received by the apparatus 104 are divided in the receiver 106 of the apparatus 104 into branches corresponding with different frequency ranges, each branch including a pulse detector that converts the optical frequency pulse component into an electrical pulse. In order to generate the received data symbol the number of pulses is calculated in each pulse position, the number of pulses is compared in different positions and a decision is made on the value of the data symbol (the position with most pulses). The PPM decoder of the receiver 106 receives a data symbol, and carries decodes said data symbol, whereby the originally sent bit string is obtained.

FIG. 2a is, a flow chart showing the method of the invention for sending an optical signal. In step 201, a data signal is generated which preferably comprises at least two data bits generated at successive instants of time. In step 202, PPM coding is conducted where the data signal is coded into a data symbol to the PPM sequence and is presented as an optical light pulse in one of the PPM sequence pulse positions. In step 203, said light pulse is coded using frequency hopping into at least two frequency pulse components of different frequencies, in accordance with the code used for the different pulse positions. In step 204, said frequency pulse components are sent to the receiver for instance through an optical fibre network. The PPM pulse sequence comprises M pulse positions. Each pulse position may include N time slots. The pulse positions are associated with the PPM modulation and the time slots with the OCDMA coding.

FIG. 2b is a flow chart showing the method of the invention for receiving an optical signal. In step 205, one or more frequency pulse components are received at a particular instant of time, the frequency pulse compounds comprising light pulses of different frequencies. In step 206, the frequency pulse components are converted from an optical pulse to an electrical pulse. In step 207, frequency hopping decoding is conducted in order to delay said frequency pulse components in relation to one another to the correct instants of time. In step 208, measuring the number of frequency pulse components in different pulse positions or the height of the frequency pulse components or both generates a PPM sequence data symbol, and the pulse position including the largest number of pulses or the highest frequency pulse component height is selected as the data symbol. In step 209, the data symbol is demodulated to detect the original data bits.

FIG. 2c is a flow chart showing an alternative method of the invention for receiving an optical signal. In step 211, one or more frequency pulse components are received at a particular instant of time, the frequency pulse components comprising light pulses of different frequencies. In step 212, the frequency pulse components are separated into branches corresponding with a particular frequency range. In step 213, each branch converts the frequency pulse components from an optical pulse into an electrical pulse. In step 214, frequency hopping decoding is conducted in order to delay said frequency pulse components in relation to one another to the correct instants of time. In step 215, measuring the number of frequency pulse components in different pulse positions or the height of the frequency pulse components or both generates a PPM sequence data symbol, and the pulse position including the largest number of pulses or the highest frequency pulse component height is selected as the data symbol. In step 216, the data symbol is decoded to detect the original data bits.

FIG. 3a is a block diagram showing a transmitter apparatus 100 according to an embodiment of the invention, the transmitter apparatus comprising a processor 310 and a memory 311 for carrying out the functions of said transmitter apparatus 100. The transmitter apparatus 100 may also comprise at least one application 312, such as a computer program product for allowing said transmitter apparatus 100 to operate as shown in said application. The transmitter apparatus 100 also comprises a data source 313 for generating a data signal, a PPM encoder 314 for pulse position modulating said data signal, a light pulse source 315 for presenting the pulse position modulated data signal as an optical pulse, a frequency hopping encoder 316 for presenting said optical pulse as at least two frequency pulse components, and a connection 317 for connecting said transmitter apparatus to the optical network, for example.

The data source 313 generates a digital data signal that preferably comprises at least two consecutive data bits. The PPM encoder codes said data signal into a pulse position modulated data symbol to a PPM sequence pulse position that can be presented in accordance with PPM signalling as an individual light pulse in an M available pulse position as shown in FIG. 3b. In the example case, there are 8 (M=8) pulse positions, in which case pulse position 0 corresponds to the bit string 0,0,0 received by the PPM encoder and correspondingly pulse position 7 corresponds to the bit string 1,1,1. In the example case the PPM encoder has received the bit string 1,0,0 that corresponds with data symbol “4”, i.e. the pulse in pulse position 4. The data symbol is generated in the PPM encoder as an optical pulse 112 by receiving the light pulse from the light pulse source 315. The PPM sequence is sent to the frequency hopping encoder 316 as consecutive instants of time in such a manner that each of the eight pulse positions in the PPM sequence corresponds to a particular consecutive instant of time.

The pulse position modulated data symbol, or optical pulse 112, is decoded using frequency hopping to the PPM frequency hopping sequence as shown in FIG. 3c; said PPM frequency hopping sequence comprising pulses positions 0 to 7 in the example case. The frequency hopping encoder 316 codes said optical pulse 112 in time and frequency domain into frequency pulse components of different frequencies 113 to 115, and spreads the pulses to different pulse positions to the spreading interval formed by the SI (spreading interval) pulse position. In the example case, the spreading interval SI=4 comprises pulse positions 4 to 7. Each pulse position can be further divided into two or more time slots TS, whereby the length L of the code can be increased. The length of the code is thus the product of the spreading interval and the time slots L=SI*TS. In the example case, each pulse position 0 to 7 is divided into three time slots, in which case the length of the code is L=12. After frequency hopping decoding, the frequency hopping component 113 is located in the first time slot of time pulse position 4 in the frequency hopping sequence, the frequency pulse component 114 is located in the first time slot of time pulse position 5 and the frequency pulse component is located in the second time slot of time pulse position 7. Finally, the PPM frequency hopping sequence comprising time pulse positions 0 to 7 is sent through a connection 317 to the optical network, for example.

FIG. 4a is a block diagram showing a receiver apparatus 106 according to an embodiment of the invention, the receiver apparatus comprising a processor 410 and a memory 411 for carrying out the functions of said receiver apparatus 106. The receiver apparatus 106 may also comprise at least one application 412, such as a computer program product for allowing said receiver apparatus 106 to operate as shown in said application. The receiver apparatus 106 also comprises a connection 413 for connecting said apparatus 106 to an optical fibre network, for example, and for receiving optical frequency pulse components, a frequency hopping decoder 414 for delaying said frequency pulse components to the desired time slots, division means 415 for dividing the frequency pulse components into branches corresponding to a particular frequency range, detection means 416 for detecting the frequency pulse components as electrical pulses in each branch, generation means 417 for generating a data symbol of electrical pulses, and a PPM decoder for decoding said data symbol to the original bit string. The decoder 414 can alternatively also be placed between the means 415 and 416 or between the means 416 and 417. The frequency hopping decoder 414 restores the received optical frequency pulse components 113 to 115 to the same pulse position as shown in FIG. 4b where they were after the PPM coding. The frequency pulse components possibly sent by other transmitters are randomly divided into different time slots of the sequence. A pulse sent by the transmitter 100 can be detected in the first time slot (references 113 to 115) of pulse position 4. The received pulse is divided by means of the divider 415 into branches corresponding to the different frequency ranges as shown in FIG. 4c. Each branch include a specific detector, which are indicated in FIG. 4c by terms detector 1, detector 2 and detector 3. The detector detects a frequency pulse component and converts it further from the optical mode into the electrical mode. FIG. 4d shows the detected bits in the different pulse positions 0 to 7 and in the branches corresponding to the different frequencies. The decision-making circuit 417 counts together the values of the bits detected during each pulse position in the sequence, and the pulse position where most bits are detected is selected as the data symbol. In the example case, 1 pulse is received at pulse position 0, and 2 pulses are received at pulse position 1, 0 pulses are received at pulse position 2, 2 pulses are received at pulse position 3, 3 pulses are received at pulse position 4, i.e. the electrical pulses converted from the frequency pulse components 113 to 115 etc. The decision-making circuit 417 decides upon the data symbol, which in the example case is “4”. The data symbol is further decoded in the PPM decoder 418, whereby the original bit string 1,0,0 is obtained. FIG. 4a shows the receiver of more than one user, in which the receiver apparatus 106 also comprises a specific decision-making circuit 419 for each user and a PPM decoder 420.

FIG. 5a shows a frequency pulse receiver 500 according to an embodiment of the Invention comprising a decoder 513 for decoding the frequency pulse components, a photo diode 505 that converts the frequency pulse component into an electrical pulse. The electrical pulse formed by the photo diode 505 is received using a comparator 509, in which the electrical pulse is compared to a preset threshold value that may be for instance a part, preferably half, of the maximum value of the signal pulse. “1”-bit is sent to the decision-making circuit 512 if the size of the pulse exceeds the preset threshold value, and correspondingly “0” bit if the size of the pulse goes below said threshold value. The decision-making circuit 512 allows deciding upon the value of the bit sent from the transmitter on the basis of the received bits. Said decision-making circuit may for instance be an AND port. A certain number of consecutive time slots forms a sequence, or a data symbol, which is received in a PPM decoder 514 that decodes it into the original data bits after having received the data symbol.

FIG. 5b shows a frequency pulse receiver according to an alternative embodiment of the invention. The receiver 500 comprises a decoder 513 for decoding frequency pulse components, one or more frequency selective components 501 to 503, such as a wavelength-division multiplexer WDM, which may be based on for example an interleaver, an arrayed waveguide grating AWG, fiber Bragg grating FBG or a filter that is able to separate at the same instant of time at least two frequency pulses on different frequencies. Said frequency selective component may also detect more than two frequency pulses at the same instant of time. The frequency components are received by means of photo diodes 504 to 507. The receiver 500 comprises at least one photo diode for each frequency component. The photo diode converts the frequency pulse into an electrical pulse. Each electrical pulse formed of a photo diode is received by a comparator 508 to 51 1, in which the electrical pulse is compared with a predetermined threshold value, which can be for example a part, preferably half, of the maximum value of the signal pulse. “1”-bit is sent to the decision-making circuit if the size of the pulse exceeds the preset threshold value, and correspondingly “0”-bit, if the size of the pulse goes below said threshold value. The decision-making circuit 512 decides upon the value of the bit sent from the transmitter on the basis of the received bits. Said decision-making circuit may be for instance an AND port. A certain number of consecutive time slots form a sequence, or a data symbol, which is received in the PPM decoder 514 that decodes it into the original data bits after having received the data symbol.

FIG. 6a shows an alternative embodiment for receiving frequency pulse components. The receiver comprises at least one frequency selective component 601 that allows separating the received frequency pulses from one another to at least two different frequency ranges. In the example case, the frequency selective component 601 receives frequency pulses on four different frequency ranges, whereof for instance two frequency pulses on a higher frequency range are directed to a photo diode 602 and correspondingly two frequency pulses on a lower frequency range are directed to a photo diode 603. The photo diode 602 (correspondingly the photo diode 603) generates an electrical pulse signal of the received frequency pulse component that is further received using a comparator 604 (correspondingly a comparator 605). The comparator 604 (correspondingly the comparator 605) compares the size of the received pulse signal with a predetermined threshold value, which may be a part, preferably more than half, for instance ¾, of the maximum value of the pulse signal. If the size of the signal pulse exceeds said threshold value, a digital signal depicting “1”-bit is for instance sent to the decision-making circuit, otherwise a signal depicting “0”-bit is sent. The signals of the comparators 604 and 605 are received on a decision-making circuit 606, where signal pulses received at a particular instant of time are compared, and if both signal pulses are 1-bits, then 1-bit is generated at the output of the decision-making circuit at said instant of time. Correspondingly, if one or both signals received by the decision-making circuit are 0-bits, then 0-bit is generated at the output of the decision-making circuit at said instant of time. The bits are directed from the decision-making circuit to a PPM decoder 607 that decodes the data symbol to the original bit string.

FIG. 6b shows a frequency pulse receiver comprising an integrated combination of a wavelength-division multiplexer and a photo detector 630 that further comprises an input 632 for receiving a light signal pulse, the light signal comprising frequency pulse components, a decoder 636 for decoding said frequency pulse components, a wavelength-division multiplexer 631, a waveguide 633 and a photo detector matrix 634 for distinguishing frequency pulses from one another. The pulse signal is sent further from the photo detector matrix 634 to a decision-making circuit 635, where the final decision is made upon the value of the received bit by comparing the signal of each photo detector to one another at a particular Instant of time. The system according to FIG. 6b can easily and cost-effectively be implemented on the same circuit. The use of periodic frequency selective components, such as interleavers, in the frequency pulse receivers, enables to employ similar receivers on different WDM channels, and thereby to obtain material and economical benefits.

FIG. 7a shows an apparatus 700 according to an alternative embodiment, where dispersion compensation is used. The compensation is based on delay lines 706 located in each branch receiving frequency pulses in the receiver. Said system is applicable to be used for example in OCDMA systems, where frequency hopping and spectral coding is used.

The dispersion is created in the optical fibre, since signals of different frequencies travel in the fibre at different rates. In the OCDMA system the dispersion widens the pulse while it travels forward in the optical fibre. The widening of the pulse is proportional to the distance travelled and to the frequency of the pulse that limits the length of the:transmission path and complicates the detection of the pulse in the receiver.

The compensation in the receiver can be used to reduce the effect of the dispersion in the OCDMA system. The compensation have such an effect on the frequency pulses that they can be broader, in which case the part of the noise, such as thermal and beat noise, can be reduced in the receiver. In addition, more frequency pulses can be used in coding that allows longer codes and thus more users and more power from the broadband source.

The frequency pulse receiver 700 detects each individual frequency pulse and counts the number of frequency pulses received at a particular instant of time. The received frequency pulses are decoded in a decoder 714 and divided according to frequency to photo diodes 702 to 705 using for example a WDM 701 functioning as the frequency selective multiplexer. The photo diodes 702 to 705 convert each frequency pulse to a corresponding electrical pulse, which is compared by means of comparators 707 to 710 to a particular predetermined threshold value. The comparator 707 to 710 sends to a decision-making circuit 711 a pulse corresponding to 1-bit if the signal to be compared exceeds the threshold value, and correspondingly a pulse corresponding to 0-bit if the signal to be compared is smaller than said threshold value. The decision-making circuit 711 decides upon the value of the bit sent from the transmitter on the basis of the received bits. The bits are directed from the decision-making circuit 711 to a PPM decoder 712, which generates a bit symbol of the received consecutive bits.

As the frequency pulses do not arrive simultaneously at the receiver owing to the dispersion, the dispersion must be compensated among the frequency pulses so that the decision-making circuit receives the signal belonging to the same instant of time at the same time. Compensation can be carried out for example in such a manner that a delay line 706 is placed between for instance the photo diode and the comparator in each branch, the delay line enabling to minimize the phase deviation of the frequency pulse travelling in each branch to other corresponding frequency pulses.

The delay line 706 may for example be a certain length of optical fibre and it may alternatively also be placed between the frequency selective component 701 and each photo diode 702 to 705.

In addition, the delay line 712 can be placed between a synchronizer 713 of the comparators and each comparator 707 to 710 as shown in FIG. 7b. As the frequency pulses do not arrive simultaneously to the decision-making circuit 711 in this case, said arrangement requires that a second delay line 706 is also placed between the comparators 707 to 710 and the decision-making circuit 711.

FIG. 8a shows an apparatus 800 according to an embodiment of the invention where frequency hopping decoding is employed. Frequency hopping decoding is carried out in the frequency pulse receiver, in which case a separate OCDMA decoder is not required. An alternative for carrying out the decoding is to use tunable electrical delays 806, which are placed between the photo diodes and the comparators.

In the frequency pulse receiver the frequency selective component 801 (such as WDM) separates the frequency pulse of each received coded frequency pulse sequence to a specific branch based on the frequency of the pulse. In each branch, a photo diode 802 to 805 receives an optical pulse and converts it into an electrical pulse. After the conversion, the sequence is decoded by adding the optical delay lines 806 based on the coding to each branch. Thus, the frequency pulse components originating from a light pulse starting from a particular transmitter can temporally be placed into the same place. Said delay lines can be for example tunable, thus enabling to change the codes more easily. The decoded frequency pulses arrive at the decision-making circuit 811, and the right decision concerning the value of the received bit can be made.

The receiver according to the invention shown in the previous Figure can be implemented as a frequency hopping OCDME receiver for multiple users in such a manner that the received signals are at first separated into branches corresponding to each frequency pulse component using the frequency selective component 801. Concerning the examples mentioned above, the received signal is divided into four branches. Each branch corresponds to a frequency pulse on a particular frequency band. Each branch comprises a photo diode 802 to 805, by which the frequency pulse is further converted into an electrical pulse signal. The same frequency selective components and photo diodes are used to receive the signals of more than one user. FIG. 8a shows a receiver of two different users, but receivers of more users can also be formed in a similar manner. The electrical pulse signals are decoded in a decoder 806 and a decoder 816. Comparators 807 to 810 send a pulse equaling 1-bit to the decision-making circuit 811 and comparators 817 to 820 send the same to a decision-making circuit 821, if the signal to be compared exceeds the threshold value, and correspondingly a pulse equalling 0-bit if the signal to be compared is smaller than said threshold value. The decision-making circuit 811 makes the decision concerning the value of the bit sent from the transmitter based on the bits received from the comparators 807 to 810, and a PPM demodulator 812 generates a bit symbol from the received consecutive bits for user 1. Correspondingly the decision-making circuit 821 makes a decision concerning the value of the bit sent from the transmitter based on the bits received from the comparators 817 to 820, and a PPM demodulator 822 generates a bit symbol of the received consecutive bits for user 2. Since the signal division is not performed while the signal is in optical mode but when the signal is in electrical mode, the eventual losses caused by dividing the optical signal can be avoided.

When more than two users are concerned, the electrical pulse mode signal is further divided into N branches, where N is the number of users. Another alternative to implement decoding shown in FIG. 8b is to place the tunable delay lines 806 between the comparators 807 to 810 and the decision-making circuit 811. As the frequency pulses do not arrive in this case to the comparators 807 to 810 simultaneously, a second set of tunable delay lines 812 is also placed between a clock circuit 813 and the comparators 807 to 810.

The method and apparatus of the invention can be employed for example in OOK and PPM signalling and in optical frequency hopping CDMA systems.

The implementation and embodiments of the invention are here shown by way of examples. It is obvious for those skilled in the art that the invention is not restricted to the details of the embodiments shown and that the invention can be implemented in other forms without deviating from the characteristics of the invention. The illustrated embodiments should be regarded as instructive not restrictive. Thus, the possibilities to implement and use the invention are only restricted by the accompanying claims. The different alternatives to implement the invention defined in the claims including the equivalent implementations are included within the scope of the invention.

1. A method for generating an optical data signal of a digital data signal comprising at least two data bits, where said data signal is converted into a data symbol of the M-ary number system, characterized by comprising the steps of
pulse position modulating said data symbol to an optical pulse sequence, and
frequency hopping coding said optical pulse sequence to an optical data signal.

2. A method as claimed in claim 1, characterized in that said optical pulse sequence comprises at least two pulse positions and an optical pulse in at least one of said pulse positions.

3. A method as claimed in claim 2, characterized in that said optical pulse sequence also comprises at least one time slot in each pulse position.

4. A method as claimed in claim 3, characterized in that said optical pulse sequence is coded using frequency hopping into at least two frequency pulse components into at least two time slots in said optical pulse sequence.

5. A method as claimed in claim 3, characterized in that said frequency pulse components have a different frequency.

6. A method for generating a digital data signal of a received optical data signal, characterized in that said optical data signal is pulse position modulated and coded using frequency hopping and comprises at least two frequency pulse components, and the method comprises the steps of
receiving frequency pulse components,
converting said frequency pulse components into electrical pulses,
performing frequency hopping decoding for said received frequency pulse components or for said electrical pulses by delaying said frequency components or said electrical pulses in relation to one another to the same instant of time,
calculating the number of said electrical pulses in the different pulse positions of the PPM sequence,
selecting the pulse position in the PPM sequence with most pulses as the data symbol, and
pulse position demodulating said data symbol to a data bit string.

7. A method as claimed in claim 6, characterized in that the frequency pulse components are also divided into at least two different branches based on the frequency of the frequency component.

8. A method as claimed in claim 7, characterized in that each one of said branches comprises the steps of
converting said frequency pulse components into electrical pulses,
conducting frequency hopping decoding for said received frequency pulse components or said electrical pulses by delaying said frequency pulse components or said electrical pulses in relation to one another to the same instant of time,
calculating the number of said electrical pulses in the different pulse positions in the PPM sequence.

9. A method as claimed in claim 8, characterized in that the pulse position in said PPM sequence comprising most pulses, when calculating together the pulses of the corresponding pulse position in each branch, is selected as the pulse position modulated data symbol.

10. A method as claimed in claim 9, characterized in that said data symbol is also pulse position demodulated to a data bit string.

11. A transmitter apparatus (100) for sending an optical data signal in an optical CDMA system, the apparatus comprising a data source (313) for generating a data signal comprising at least two data bits, a light pulse source (315) for presenting said data signal as an optical signal, transmission means (317) for sending said optical signal from the transmitter apparatus (100), and conversion means for converting said data signal into a data symbol of the M-ary number system, characterized in that said transmitter apparatus (100) further comprises
modulation means (314) for pulse position modulating said data symbol to an optical pulse sequence, and
a frequency hopping encoder (316) for coding said optical pulse sequence to an optical data signal in time and frequency domain.

12. A receiver apparatus as claimed in claim 11, characterized in that the apparatus further comprises generation means (314) for generating said optical pulse sequence comprising at least two pulse positions and said optical pulse Is in at least one of said pulse positions.

13. A receiver apparatus (106) for receiving an optical data signal in an optical CDMA system, the receiver apparatus (106) comprising means (413) for receiving the optical data signal at the receiver apparatus (106), characterized in that said optical data signal is pulse position modulated and coded using frequency hopping and comprises at least two frequency pulse components, and the receiver apparatus further comprises
reception means (413) for receiving at least two optical frequency pulse components,
conversion means (416) for converting the frequency pulse components into corresponding electrical pulses,
decoding means (414) for conducting frequency hopping decoding for said received frequency pulse components, for said divided frequency pulse components or for said electrical pulses by delaying said frequency pulse components or said electrical pulses in relation to one another to the same instant of time,
calculation means (417, 418) for calculating the number of said electrical pulses in the different pulse positions of the PPM sequence.

14. An apparatus as claimed in claim 13, characterized in that the apparatus further comprises division means (415) for dividing the frequency pulse components into at least two different branches based on the frequency.

15. An apparatus as claimed in claim 14, characterized in that the apparatus further comprises in each one of said branches
conversion means (416) for converting said frequency pulse components into electrical pulses,
frequency hopping decoding means (414) for conducting frequency hopping coding for said received frequency pulse components or for said electrical pulses by delaying said frequency pulse components or said electrical pulses in relation to one another at the same instant of time,
calculation means (417) for calculating the number of said electrical pulses in the different pulse positions of the PPM sequence,
generation means (417) for generating a data symbol of the PPM sequence, and
demodulation means (418) for demodulating said data symbol to a data bit string.

16. An apparatus as claimed in claim 15, characterized in that the apparatus further comprises selection means (417) for selecting the data symbol by selecting the pulse position comprising most pulses, when calculating together the pulses of the corresponding pulse position in each branch, as the data symbol.

17. An apparatus as claimed in claim 14, characterized in that the apparatus further comprises pulse position demodulation means (418, 420) for demodulating said data symbol to a data bit string.

18. A system comprising an optical fibre network (105) at least two transceiver apparatuses (101 to 104), which are able to send and receive optical data signals through said fibre network, a data source (313) for generating a data signal comprising at least two data bits, a light pulse source (315) for presenting said data signal as an optical signal, transmission means (317) for sending said optical signal, and means (413) for receiving the optical data signal, and conversion means for converting said data signal into a data symbol of the M-ary number system, characterized in that said optical data signal is pulse position modulated and coded using frequency hopping and comprises at least two frequency pulse components, and that the system also comprises
modulation means (314) for pulse position modulating said data symbol to an optical pulse sequence,
a frequency hopping encoder (316) for coding said optical pulse sequence in time and frequency domain to an optical pulse signal,
reception means for receiving at least the optical pulse signal comprising at least two optical frequency pulse components,
conversion means for converting said frequency pulse components using said frequency pulse detectors into corresponding electrical pulses,
coding means for conducting frequency hopping decoding for said received frequency pulse components or for said electrical pulses by delaying said frequency pulse components or said electrical pulses in relation to one another to the same instants of time,
calculation means for calculating the number of said electrical pulses in the different pulse positions of the PPM sequence,
selection means for selecting a data symbol by selecting the pulse position with most pulses as the data symbol, and
demodulation means for demodulating said data symbol to a data bit string.

19. A system as claimed in claim 18, characterized in that said sequence comprises at least two pulse positions and said optical pulse sequence is in at least one of said pulse positions.

20. A system as claimed in claim 19, characterized in that the system further comprises division means for dividing the frequency pulse components based on the frequency of the pulse component into at least two different frequency pulse detectors.
